(19) United States
(12) Patent Application Publication
(10) Pub. No.: US 2014/0133816 A1
(43) Pub. Date: May 15, 2014

(54) Holey Fiber

(71) Applicant: Furukawa Electric Co., Ltd., Tokyo (JP)

(72) Inventor: Kazunori MUKASA, Tokyo (JP)

(73) Assignee: Furukawa Electric Co., Ltd., Tokyo (JP)

(21) Appl. No.: 14/157,612

(22) Filed: Jan. 17, 2014

Related U.S. Application Data
(63) Continuation of application No. PCT/JP2012/067834, filed on Jul. 12, 2012.

(30) Foreign Application Priority Data
Aug. 1, 2011 (JP) 2011-168683

(51) Int. Cl. G02B 6/02

(52) U.S. Cl. CPC G02B 6/02347
USPC 385/123

(57) ABSTRACT

A holey fiber includes a core portion and a cladding portion in which holes located in the outer periphery of the core portion and arranged around the core portion in layers, and a low refractive index layer having an internal diameter that is equal to or larger than four times a mode field radius of light in the core portion and having a refractive index lower than the core portion are formed.

CROSS-REFERENCE TO RELATED APPLICATION(S)

This application is a continuation of International Application No. PCT/JP2012/067834, filed on Jul. 12, 2012 which claims the benefit of priority of the prior Japanese Patent Application No. 2011-168683, filed on Aug. 1, 2011, the entire contents of which are incorporated herein by reference.

### BACKGROUND OF THE INVENTION

1. Field of the Invention

The present invention relates to a holey fiber.

2. Description of the Related Art

A holey fiber (HF) or a photonic crystal fiber (PCF) is a new type of optical fiber that realizes optical transmission where the average refractive index in the cladding is reduced by having holes arranged in the cladding and the principle of total reflection is used. By using the holes for controlling refractive index of the optical fiber, the holey fiber can realize unique characteristics that cannot be realized by conventional optical fibers, such as an endlessly single mode characteristic (ESM) and a zero-dispersion wavelength shifted toward a side of an extremely short wavelength. Note that the ESM means to have no cut-off wavelength, and it is a characteristic that enables optical transmission with high transmission rate over a wide band (see K. Saitoh, Y. Tsuchida, M. Koshiba, and N. A. Mortensen, “Endlessly single-mode holey fiber: the influence of core design,” Optics Express, vol. 13, pp. 10833-10839 (2005)).

Meanwhile, the holey fiber is also expected to be applied to a transmission medium with low optical nonlinearity (large core) for use in optical communications and fiber lasers. For example, in M. D. Neilsen et al., “Predicting macrobending loss for large-mode area photonic crystal fibers”, OPTICS EXPRESS, Vol. 12, No. 8, pp. 1775-1779 (2004), characteristics of a photonic crystal fiber in which a core diameter is enlarged to 20 μm or more is reported.

### SUMMARY OF THE INVENTION

It is an object of the present invention to at least partially solve the problems in the conventional technology.

In accordance with one aspect of the present invention, a holey fiber includes a core portion and a cladding portion in which holes located in an outer periphery of the core portion and arranged around the core portion in layers, and a low refractive index layer having an internal diameter that is equal to or larger than four times a mode field radius of light in the core portion and having a refractive index lower than the core portion are formed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic cross-sectional view of a holey fiber according to an embodiment;

FIG. 2 is a diagram illustrating structural parameters and optical characteristics of holey fibers according to calculation examples;

FIG. 3 is a diagram illustrating relationships between relative refractive-index differences Δ and bending losses;

FIG. 4 is a diagram illustrating relationships between Λ and V values;

FIG. 5 is a diagram illustrating relationships between Λ and confinement losses;

FIG. 6 is a diagram illustrating relationships among Λ, d/Λ, and Aeff; and

FIG. 7 is a diagram illustrating relationships between a wavelength and a bending loss in case of no depressed layer.

### DETAILED DESCRIPTION OF THE PREFERRED EMBODIMENTS

Hereinafter, an embodiment of a holey fiber according to the present invention will be described in detail with reference to the drawings. Note that the invention is not limited by the embodiment. In the present specification, a bending loss means a macro bending loss that the holey fiber has for bending with a diameter (bending diameter) of 20 mm. The terms not particularly defined in the present specification follow the definitions and measuring methods according to the ITU-T (International Telecommunication Union) G. 650. 1. Hereinafter, the holey fiber will be appropriately described as “HF”.

In holey fibers having an enlarged core diameter or effective core area (Aeff), a problem has been reported, in which a bending loss at a side of a shorter wavelength is increased.

For example, in a conventional holey fiber, when the bending loss at a wavelength of 1.55 μm is increased, the bending loss in a shorter wavelength is further increased. Therefore, there is a problem that, even if the holey fiber has the characteristic of ESM, it is difficult to use the holey fiber in a wide wavelength bandwidth when Aeff is enlarged.

According to an embodiment of the present invention, effects to suppress an increase in bending loss compared to a conventional holey fiber while enlarging Aeff are exerted.

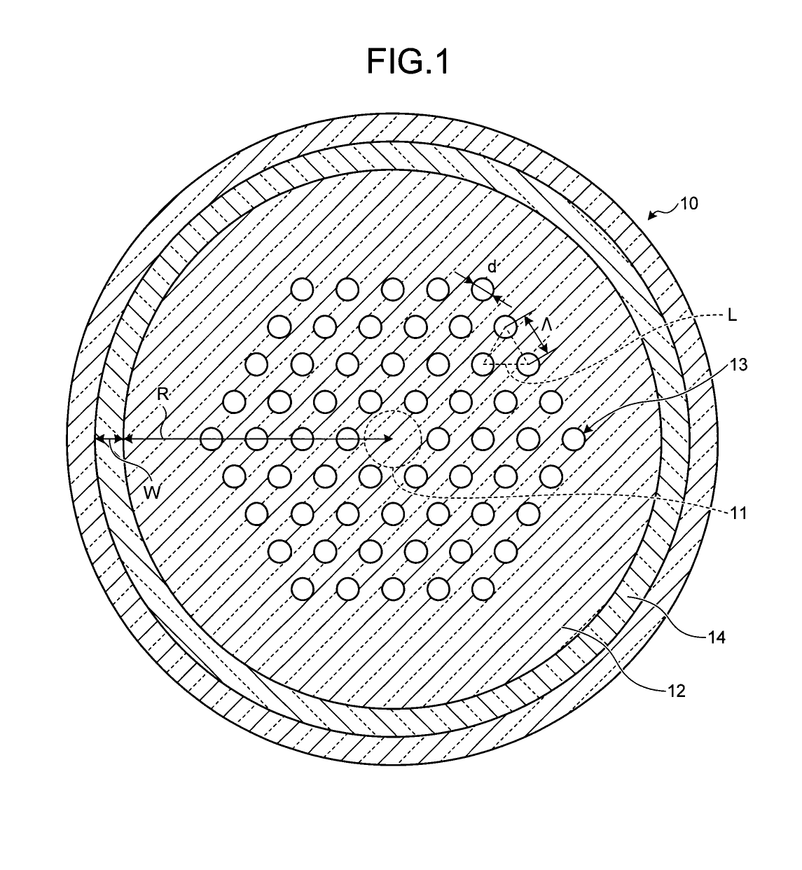

FIG. 1 is a schematic cross-sectional view of an HF according to an embodiment of the present invention. As illustrated in FIG. 1, an HF 10 has a core portion 11 located nearly in the center of the HF 10 and a cladding portion 12 located in the outer periphery of the core portion 11. Both of the core portion 11 and the cladding portion 12 are made of pure silica glass without dopants for adjustment of refractive index.

The cladding portion 12 has a plurality of holes 13 arranged in layers around the core portion 11. Note that the number of layers of the holes 13 in the HF 10 is four where a combination of the holes 13 arranged on each apex and each side of a regular hexagon around the core portion 11 is considered as a single layer. The holes 13 are arranged in layers and are arranged to form a triangular lattice L. The diameter of each of the holes 13 is d, and a lattice constant of the triangular lattice L, i.e. a distance between centers of the holes 13 is Λ.

Further, a depressed layer 14 that is a low refractive index layer having a lower refractive index than the core portion 11 and the cladding portion 12 is formed in the cladding portion 12. The depressed layer 14 is made of silica glass which is doped with fluorine (F), which is a dopant decreasing the refractive index. The depressed layer 14 is formed into a ring shape in which an internal radius around a central axis of the core portion 11 is R and a thickness is W. Further, the depressed layer 14 is formed outside a region where the holes 13 are formed. Therefore, the depressed layer 14 and the holes 13 are arranged not to overlap with each other. Note that it is favorable to set the thickness of the portion outside the depressed layer 14 of the cladding portion 12 to be 5 μm or more.

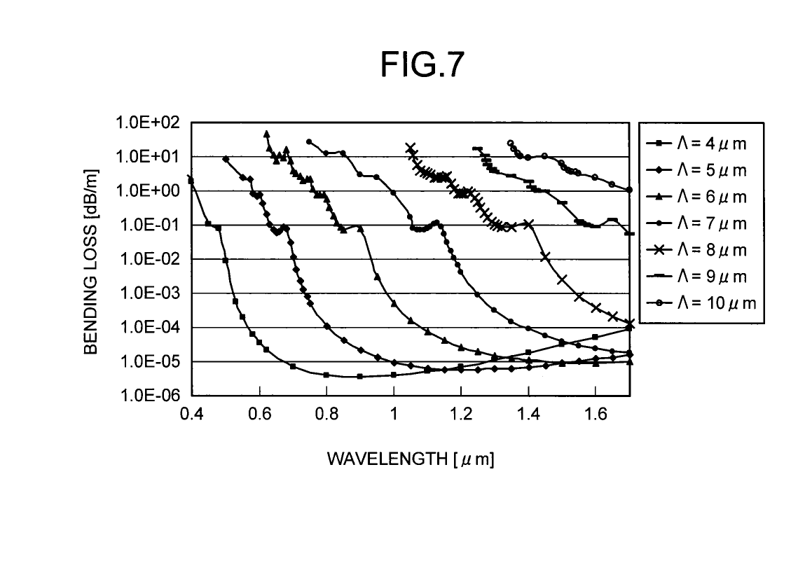

Here, FIG. 7 is a diagram illustrating relationships between wavelengths and bending losses assuming that there is no depressed layer 14 in the HF 10 illustrated in FIG. 1 and the portion of the depressed layer 14 is replaced with pure silica glass that is a material same as the cladding portion 12. Note that d/Λ is fixed to 0.43 and Λ is varied from 4 to 10 μm. As illustrated in FIG. 7, the bending loss becomes larger at a shorter wavelength side as Λ becomes larger, that is, Aeff of the core portion 11 is more enlarged. For example, when Λ is 10 μm, even if the bending loss at a wavelength of 1.55 μm is about 5 dB/m, the bending loss at a wavelength of 1.31 μm becomes 100 dB/m or more, which is large. When the bending loss exceeds 100 dB/m, leakage of light from the core portion becomes large, and therefore the optical characteristics become unstable.

In contrast, in the HF 10 according to the present embodiment, an increase in bending loss is suppressed because of the formation of the depressed layer 14. Especially, in the HF 10, the depressed layer 14 having the internal diameter that is equal to or larger than four times a mode field radius of light in the core portion 11 is formed, so that the depressed layer 14 has an insignificant impact on the field of the light. As a result, only the increase in bending loss can be suppressed without substantially changing other optical characteristics of the HF 10. In addition, it is favorable to make the depressed layer 14 sufficiently larger than the mode field, so that confinement and propagation in a high order propagation mode by the depressed layer 14 does not occur.

Next, the optical characteristics of the HF 10 in case where the internal radius and the thickness of the depressed layer are varied in the HF 10 illustrated in FIG. 1 according to the present embodiment will be described.

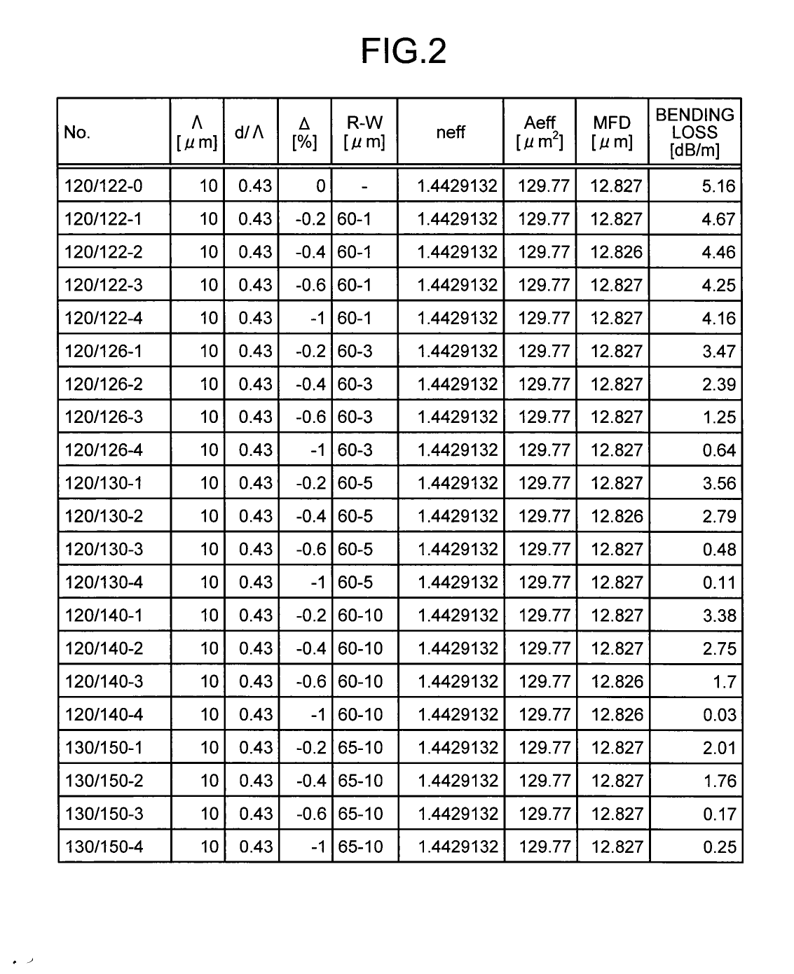

FIG. 2 is a diagram illustrating structural parameters and optical characteristics of HFs according to calculation examples. In FIG. 2, for example, “No. 120/122-1” as a calculation example indicates a calculation example in which the internal diameter of the depressed layer is 120 μm and the external diameter of the depressed layer is 122 μm. Note that “No. 120/122-0” indicates a comparative calculation example of an HF without a depressed layer. Further, “Δ” indicates a relative refractive-index difference of the depressed layer with respect to the core portion and the cladding portion. “R-W” indicates a combination of the internal radius R and the thickness W of the depressed layer. For example, “60-1” indicates that R is 60 μm and W is 1 μm. “neff” indicates an effective refractive index of the core portion. “MFD” indicates a mode field diameter. “neff”, “Aeff”, “MFD”, and the bending loss are values where the wavelength is 1550 nm.

All of the HFs illustrated in FIG. 2 have Aeff enlarged to 120 μm² or more. However, as for the bending loss, all of the calculation examples having the depressed layer have lower values than the case of No. 120/122-0 without a depressed layer. In addition, it has been confirmed that, as for the relative refractive-index difference Δ, there is an effect to further decrease the bending loss as Δ becomes smaller as long as Δ is smaller than 0% and equal to or larger than −1.0%. It has been confirmed that there is an effect to further decrease the bending loss as R becomes larger as long as R is 60 to 65 μm. It has been confirmed that there is an effect to further decrease the bending loss as W becomes larger as long as W is 1 to 10 μm, more favorably, 3 μm or more.

Further, in each calculation example of FIG. 2, neff, Aeff, and MFD take almost the same values when viewing the digits after the decimal point. That is, it has been confirmed that the existence of the depressed layer has an insignificant impact on neff, Aeff, and MFD that are the optical characteristics of the HF as long as Δ, R, and W fall within the above-described ranges. Further, as for the HFs illustrated in FIG. 2, a wavelength dispersion value is 24 ps/nm/km or less at a wavelength of 1550 nm, and thus a practical value can be obtained. In addition, as for the HFs illustrated in FIG. 2, confinement and propagation in a high order mode is not particularly observed.

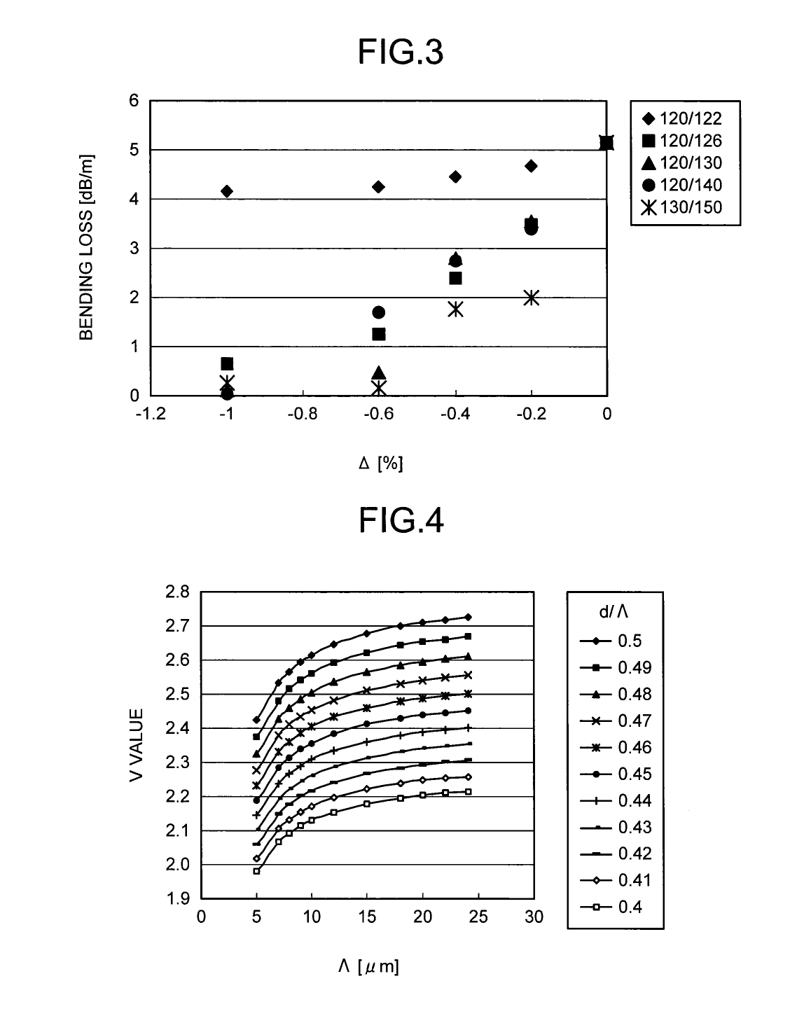

FIG. 3 is a diagram illustrating relationships between relative refractive-index differences Δ and bending losses. As is further clear from FIG. 3, there is an effect to further decrease the bending loss as Δ becomes smaller as long as Δ is smaller than 0% and equal to or larger than −1.0%. Further, it is confirmed that, as for the thickness W, there is an effect to further decrease the bending loss as W becomes larger as long as W is 1 to 10 μm, especially, there is an effect when W is 3 μm or more.

Note that it is favorable to set the relative refractive-index difference Δ to be −1.0% or more, so that the amount of fluorine to be used can be reduced, which is also favorable in terms of manufacturing.

While Λ is fixed to 10 μm and d/Λ is fixed to 0.43 in FIG. 2, favorable Λ and d/Λ are not limited to these values. Hereinafter, favorable ranges of Λ and d/Λ that are the structural parameters related to the holes 13 will be described.

First, the HF 10 is favorably configured to transmit light having a wavelength of 1550 nm in a single mode. Hereinafter, the structural parameters that realize the single mode transmission using a method using the V value disclosed in K. Saitoh et al., “Empirical relations for simple design of photonic crystal fibers”, OPTICS EXPRESS, Vol. 13, No. 1, pp. 267-274(2005) will be examined.

FIG. 4 is a diagram illustrating relationships between Λ and V values in a wavelength of 1500 nm in the HF 10 when d/Λ is varied in various values. If the V value is 2.405 or less, the single mode transmission in a wavelength of 1550 nm becomes possible. Therefore, according to FIG. 4, it is favorable to set d/Λ to fall within a range of 0.45±0.05, so that the single mode transmission can be realized where Λ falls within a range of 5 to 25 μm. Note that, as for Λ, it is favorable to set Λ to be 5 μm or more for the enlargement of Aeff. Further, it is favorable in terms of easy handling to set Λ to be 25 μm or less, so that the cladding diameter of the HF 10 is not much increased.

However, d/Λ is not limited within the range of 0.45±0.05. While the range of d/Λ that satisfies conditions of the single mode transmission varies depending on Λ and the number of layers of the holes, there is a case in which HF may transmit light in a multimode when d/Λ becomes large, and a penalty when an optical signal is transmitted becomes large. If d/Λ is small, on the other hand, the bending loss is increased. In view of these problems, it is favorable to set d/Λ to fall within a range of 0.45±0.2. Note that, as for the cladding diameter of the HF 10, it is favorable to set the cladding diameter to be 300 μm or less in terms of easy handling, so that the rigidity thereof does not become so high. Especially, it is more favorable when the cladding diameter falls within a range of 125±10 μm, similarly to a standard optical fiber.

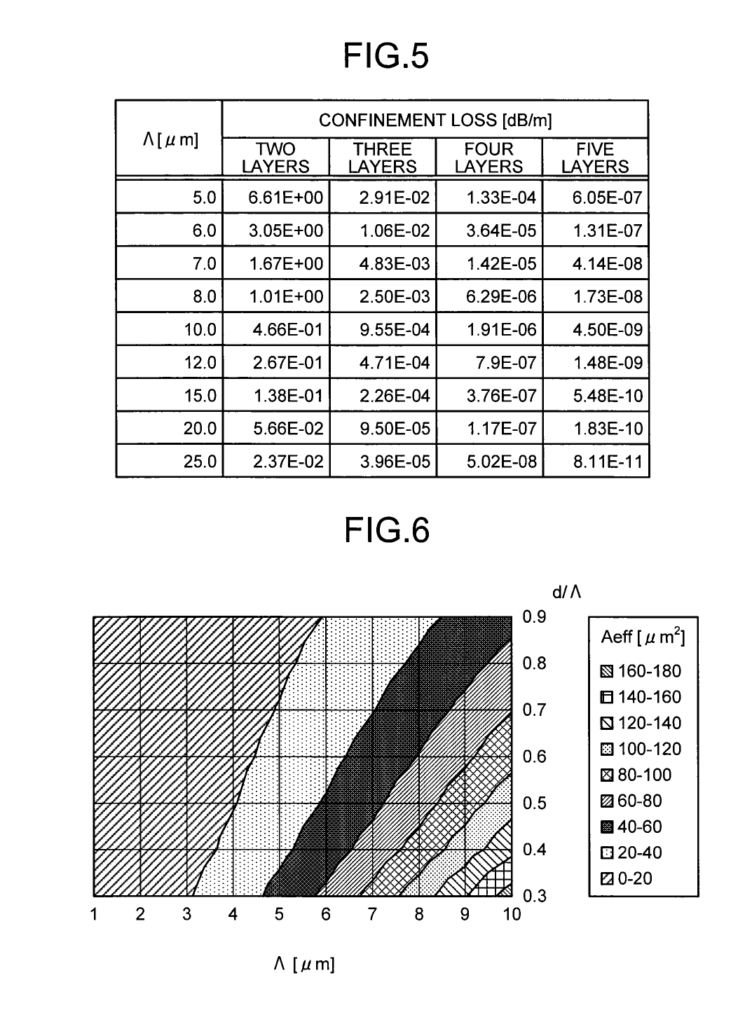

FIG. 5 is a diagram illustrating relationships between Λ and confinement losses in case where the number of layers of the holes 13 is varied in various numbers in the HF 10. Note that d/Λ is fixed to 0.45. Also, the confinement loss is a value where the wavelength is 1550 nm. “E” is a symbol representing a power of 10. For example, “2.91E-02” means “2.91×10⁻²”.

As illustrated in FIG. 5, the confinement loss becomes smaller as the number of layers of the holes becomes larger. Further, the confinement loss becomes smaller as Λ becomes larger. It is favorable to set the number of layers of the holes to be 2 or more, so that the confinement loss can be made 0.1 dB/m or less. Further, it is more favorable to set the number of layers of the holes to be 3 or more, so that the confinement loss can be made 1×10⁻⁴ dB/m or less, that is, 0.1 dB or less per 1 km.

FIG. 6 is a diagram illustrating relationships among Λ, d/Λ, and Aeff in the HF 10. Aeff is a value where the wavelength is 1550 nm. As illustrated in FIG. 6, when d/Λ is 0.43, for example, it is favorable to set Λ to be 10 μm, so that Aeff can be expanded into 120 μm² or more. Note that, as illustrated in FIG. 2, the HF 10 according to the present embodiment can suppress the increase in bending loss because of the existence of the depressed layer 14 even if Λ is made larger.

As described above, the holey fiber according to the present embodiment can suppress the increase in bending loss while enlarging Aeff.

Note that the holey fiber according to the present embodiment can be manufactured by a known stack and draw method as follows, for example. That is, first, a hollow second glass tube is inserted into a hollow first glass tube made of pure silica glass. The hollow second glass tube is made of fluorine-doped glass for forming a depressed layer and has the external diameter that is about the internal diameter of the first glass tube. Next, a number of hollow glass capillaries made of pure silica glass for forming holes is inserted into the second glass tube and stacked to form a preform. The preform is then drawn, so that the holey fiber can be manufactured.

Further, the depressed layer 14 is formed outside the region where the holes 13 are formed in the holey fiber according to the embodiment. However, the location of the depressed layer is not limited to the above embodiment. Any depressed layer can be formed as long as the one has the internal diameter that is equal to or larger than four times the mode field radius of the light in the core portion. Therefore, the holes and the depressed layer may be formed in locations overlapping with each other. Note that, when such a holey fiber is manufactured, holes may just be formed, by a drilling method, in a solid preform made of pure silica glass in which a depressed layer has been formed, and the material may just be drawn.

The locations of the holes are not limited to the triangular lattice manner and may be formed in a rectangular lattice manner. Further, the diameters of the holes are not limited to a uniform size and may be non-uniform sizes.

As the wavelength of light propagated in the holey fiber according to the present invention, a wavelength band including 1550 nm, or a wavelength band of 1300 to 1600 nm used as signal light in optical fiber communication can be used.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A holey fiber comprising:
a core portion; and
a cladding portion in which a plurality of holes located in an outer periphery of the core portion and arranged around the core portion in layers, and a low refractive index layer having an internal diameter that is equal to or larger than four times a mode field radius of light in the core portion and having a refractive index lower than the core portion are formed.

2. The holey fiber according to claim 1, wherein the low refractive index layer is formed outside a region where the plurality of holes is formed.

3. The holey fiber according to claim 1, wherein a thickness of the low refractive index layer is larger than 0 μm, and a relative refractive-index difference Δ with respect to the cladding portion is smaller than 0% and equal to or larger than −1.0% to (exclusive of 0%).

4. The holey fiber according to claim 1, wherein a thickness of the low refractive index layer is 3 to 10 μm.

5. The holey fiber according to claim 1, wherein a bending loss of the holey fiber is smaller than a bending loss of a holey fiber having the core portion and the cladding portion but not having the low refractive index layer at a wavelength of 1550 nm.

6. The holey fiber according to claim 1, wherein the plurality of holes is arranged to form a triangular lattice, d/Λ falls within a range of 0.45±0.2, and number of layers of the holes is two or more, where diameters of the holes are d [μm] and a lattice constant of the triangular lattice is Λ [μm].

7. The holey fiber according to claim 6, wherein the d/Λ falls within a range of 0.45±0.05.

8. The holey fiber according to claim 6, wherein the Λ is 5 to 25 μm.
